(19) United States
(12) Patent Application Publication
(10) Pub. No.: US 2025/0373380 A1
(43) Pub. Date: Dec. 4, 2025

(54) Service-Optimized Interface between Application and Communication Layers

(71) Applicant: Apple Inc., Cupertino, CA (US)

(72) Inventors: Kenza HAMIDOUCHE, Cupertino, CA (US); Ahmed M SOLIMAN, Munich (DE); Danila ZAEV, Munich (DE); Ayman F NAGUIB, Cupertino, CA (US); Alan G CARLTON, Los Gatos, CA (US)

(21) Appl. No.: 19/222,519

(22) Filed: May 29, 2025

Related U.S. Application Data
(60) Provisional application No. 63/654,289, filed on May 31, 2024.

(51) Int. Cl. H04L 5/00; H04L 1/00

(52) U.S. Cl. CPC H04L 5/0044; H04L 1/0005; H04L 1/0057; H04L 1/0064

(57) ABSTRACT

An apparatus configured to map a data unit to one or more representations, map each of the representations to one or more data blocks, wherein each of the data blocks comprises a weight and encode the one or more data blocks of each of the representations into one or more packets.

### PRIORITY/INCORPORATION BY REFERENCE

This application claims priority to U.S. Provisional Application Ser. No. 63/654,289 filed on May 31, 2024, entitled “Service-Optimized Interface between Application and Communication Layers,” the entirety of which is incorporated by reference herein.

### BACKGROUND

Wireless communication systems are rapidly growing in usage and constantly evolving. It is anticipated that future evolutions of the cellular standards, e.g., (3GPP standards) may include aspects of semantic communication. Some applications such as extended Reality (XR), co-presence, cloud gaming and computing offloading may have strict latency requirements that are challenging to satisfy under dynamic radio conditions and in congested resources.

### SUMMARY

Some example embodiments are related to an apparatus having processing circuitry coupled to memory, wherein the processing circuitry is configured to map a data unit to one or more representations, map each of the representations to one or more data blocks, wherein each of the data blocks comprises a weight and encode the one or more data blocks of each of the representations into one or more packets.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example hierarchical protocol data unit (PDU) structure for semantic communications according to various example embodiments.

FIG. 5 shows an architecture for service optimized representations according to various example embodiments.

FIG. 6 shows an example of data unit encoding according to various example embodiments.

FIG. 7 shows an example representation according to various example embodiments.

FIG. 8 shows an example of an application aware transport block (TB) according to various example embodiments.

FIG. 9 shows an example of ordering data blocks from the highest to the lowest priority in a TB according to various example embodiments.

FIG. 10 shows an example of TBs generated based on SDU weight according to various example embodiments.

FIG. 11 shows an example of TBs generated based on MAC SDUs that belong to a same Data Block or that have a weight within a given range according to various example embodiments.

FIG. 12 shows a first example of a global TB MAC header according to various example embodiments.

FIG. 13 shows a second example of a global TB MAC header according to various example embodiments.

FIG. 14 shows an example of TBs that are restricted to include MAC SDUs of a single data block according to various example embodiments.

### DETAILED DESCRIPTION

The example embodiments may be further understood with reference to the following description and the related appended drawings, wherein like elements are provided with the same reference numerals. The example embodiments relate to various aspects of semantic communication. Specifically, the example embodiments relate to a service-optimized representation structure and an application-optimized transport block (TB).

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a sixth generation (6G) network. However, reference to a 6G network is merely provided for illustrative purposes. The example embodiments may be utilized with any appropriate type of network and that supports semantic communications as described herein, including future evolutions of the cellular standards beyond 6G.

The example embodiments are related to semantic communications. Semantic communications differ from traditional or classic communications. Specifically, traditional communication modes use error-free deterministic communications, e.g., the data that is to be transmitted by a transmitter and received by a receiver is the actual data that is to be exchanged, e.g., data that represents pixel values of an image. In contrast, semantic communications are not limited to transmission of the actual data. Rather, semantic communications transmit semantic representations of the data, e.g., semantic data or metadata about the data that is to be transmitted. The receiver may use this semantic data or metadata to reconstruct the actual data that the transmitter intends without the transmitter sending the actual data.

One advantage of semantic communications is that the semantic representations of data, e.g., semantic data or metadata about the data to be transmitted, may be smaller than the actual data to be transmitted. To provide an example, the semantic representation of an image may be significantly smaller than the actual data of the image. This reduction in the amount of data required to exchange information between a transmitter and receiver may allow for higher throughputs to accommodate heavy traffic scenarios.

Semantic communications is not data compression. That is, traditional communication modes may use various compression algorithms to compress the size of the actual data, e.g., there are multiple forms of MPEG compression that reduce the size of video files for traditional communications. These forms of compression typically remove some of the actual data from the data being transmitted and the receiver may decode the compressed data using interpolation or other methods. Semantic communications are different from compression (or encoding) because the reduced amount of data used for semantic communications is not a subset of the actual data as in traditional communication compression.

To provide a very simple example of transmitting an image that includes a tree. Traditional communication modes need to represent each pixel of the image that includes the tree and transmit those representations of each pixel to the receiver. The receiver may decode the representations of each pixel and display the image. In contrast, in semantic communications, the semantic representation may be as simple as indicating a ‘tree.’ The receiver may then place a tree in the image. The semantic representation may be more complicated, e.g., ‘a tree with green leaves’, ‘a tree with fall color leaves’, ‘an oak tree’, etc. From this simple example, it can be seen that the amount of data used to convey the same information is significantly less using semantic communications.

The example embodiments describe different aspects for semantic communications. In a first aspect, a service-optimized representation structure that represents a data flow is described. In a second aspect, an application-optimized transport block (TB) to reduce latency and improve the handling of the data based on its relevance for the user experience and achieve the application requirements is described.

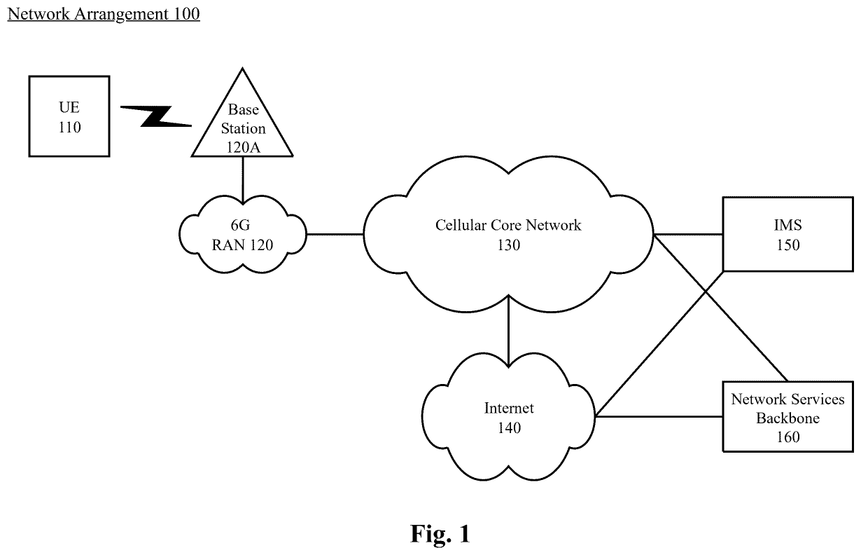

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 6G radio access network (RAN) 120. However, the UE 110 may also communicate with other types of networks (e.g., fifth generation (5G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the example embodiments, the UE 110 may establish a connection with the 6G RAN 120. Therefore, the UE 110 may have at least a 6G chipset to communicate with the 6G RAN 120.

The 6G RAN 120 may be a portion of a cellular network that may be deployed by a network carrier (e.g., Verizon, AT&T, T-Mobile, etc.). The 6G RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Any association procedure may be performed for the UE 110 to connect to the 6G RAN 120. For example, as discussed above, the 6G RAN 120 may be associated with a particular cellular provider where the UE 110 and/or the user thereof has a contract and credential information (e.g., stored on a SIM card). Upon detecting the presence of the 6G RAN 120, the UE 110 may transmit the corresponding credential information to associate with the 6G RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC), the 5G core (5GC), the 6G core (6GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

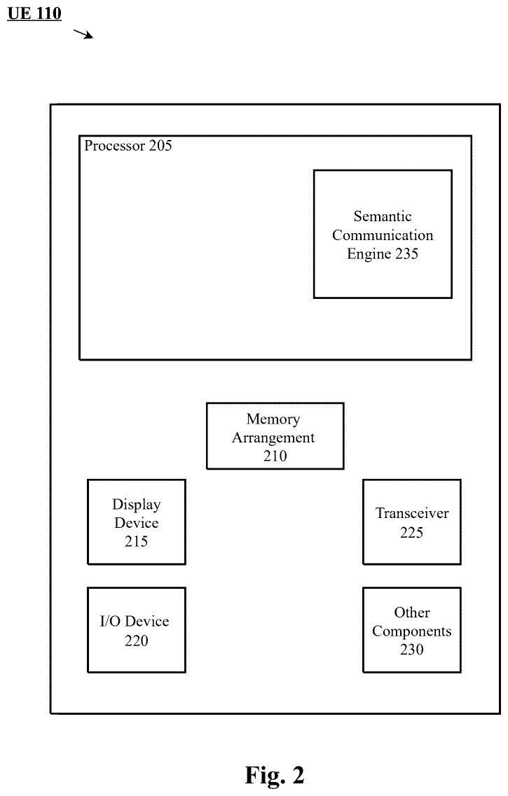

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a semantic communication engine 235. The semantic communication engine 235 may perform various operations related to semantic communications. To provide some general examples, the semantic communication engine 235 may perform operations such as, but not limited to, semantic encoding of input data including generating service optimized representations and data blocks and encoding the representations and data blocks into transport blocks for over-the-air delivery. Each of these example operations will be described in greater detail below.

The above referenced engine 235 being an application (e.g., a program) executed by the processor 205 are merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. In particular, in some examples, it is the capabilities of the UE 110 typically handled by the baseband processor that may be reduced when the UE 110 is operating in the low battery mode. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 6G-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode, decode and/or process signals (e.g., signaling from a base station of a network) for implementing any one of the methods described herein.

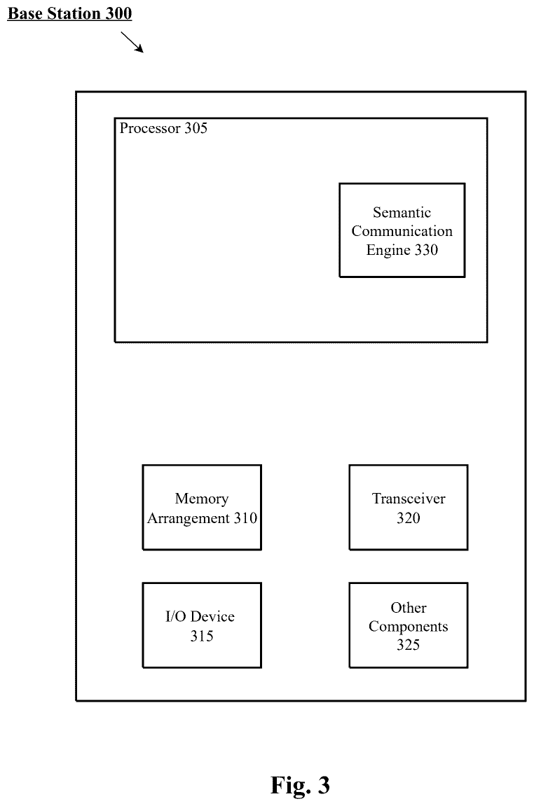

FIG. 3 shows an example base station 300 according to various example embodiments. The base station 300 may represent any base included within the network, e.g., base station 120A.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include a semantic communication engine 330. The semantic communication engine 330 may perform various operations for the base station 300 related to related to discarding PDUs of semantic communications. To provide some general examples, the semantic communication engine 330 may perform operations such as, but not limited to, semantic encoding of input data including generating service optimized representations and data blocks and encoding the representations and data blocks into transport blocks for over-the-air delivery. Each of these example operations will be described in greater detail below.

The above noted engine 330 being an application (e.g., a program) executed by the processor 305 is only an example. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some servers, the functionality described for the processor 305 is split among a plurality of processors (e.g., a baseband processor, an applications processor, etc.). In particular, in some examples, it is the operations for communicating with the UE 110 that are typically handled by the baseband processor that may be reduced when the UE 110 is operating in the low battery mode. The example embodiments may be implemented in any of these or other configurations of a server.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UEs in the network arrangement 100.

The transceiver 320 may operate on a variety of different frequencies or channels (e.g., set of consecutive frequencies). Therefore, the transceiver 320 may include one or more components to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode, decode and/or process signals (e.g., signaling from a UE) for implementing any one of the methods described herein.

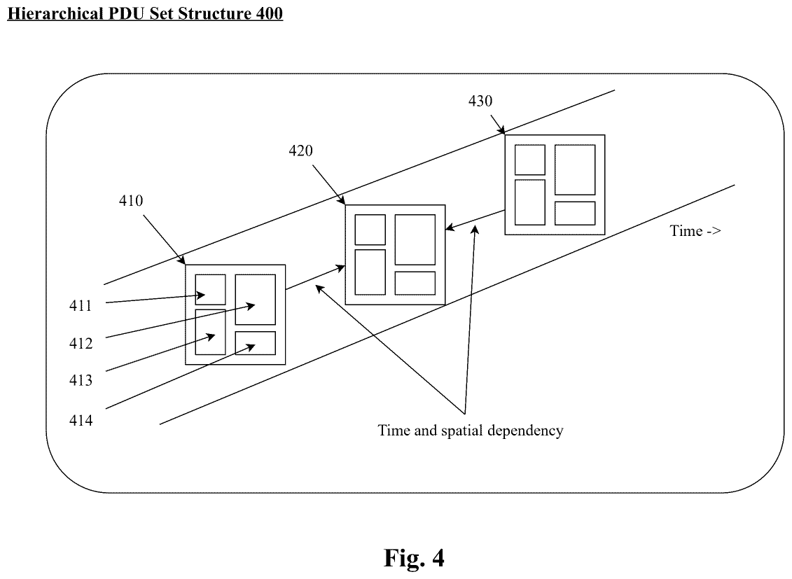

FIG. 4 shows an example hierarchical protocol data unit (PDU) structure 400 for semantic communications according to various example embodiments. The hierarchical PDU structure 400 may include representations 410-430 of any type of data flow, e.g., images, video frames, audio frames, etc. A representation may be a typical data burst generated by an application. As shown in FIG. 4, the different representations 410-430 may have time and spatial dependencies upon each other.

Within each representation 410-430, there may be blocks of data, e.g., image segments, video frame segments/slices, audio segments, etc.). For example, representation 410 may include blocks 411-414. A block describes a set of protocol data units (PDUs) that have value only if jointly received. In some example embodiments, some blocks may be soft blocks that allow a sub-packet level of priority handling. The blocks may also include dependencies and numerical weights.

Configuration of a data flow may be split into three parts to minimize redundancy. These three parts may include per flow representations (e.g., data category), per individual representation or per individual PDU.

The example embodiments use the above data structure to allow the communication layers to optimize functionalities and procedures. This may include defining metadata that should be passed to the lower layers to optimize the handling of the relevant data and better achieve application requirements.

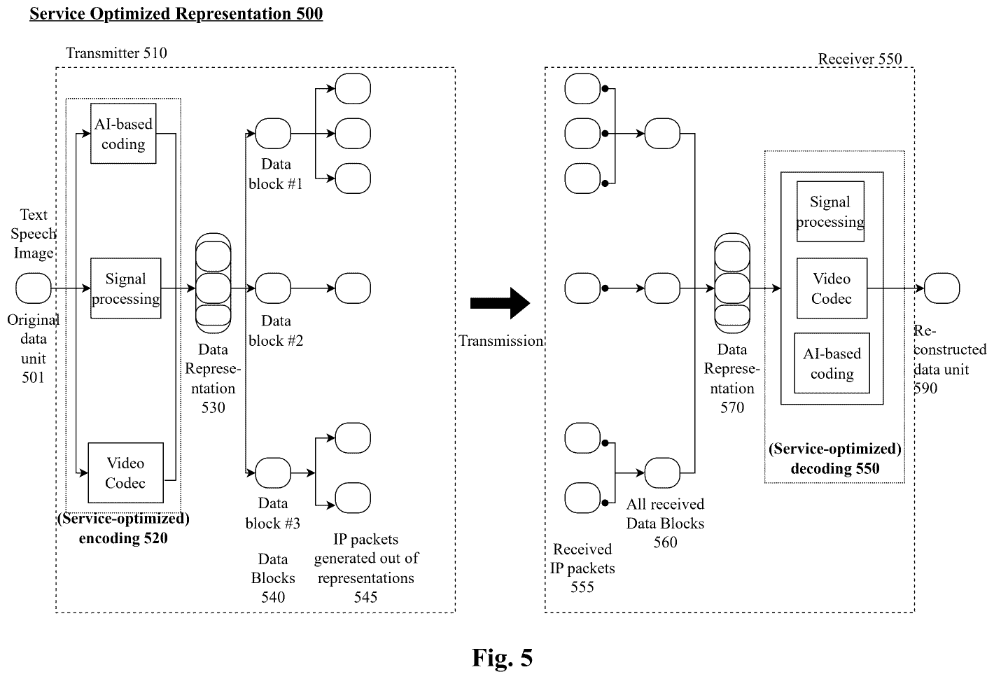

FIG. 5 shows an architecture 500 for service optimized representations according to various example embodiments. The architecture 500 comprises a transmitter 510 and a receiver 550. The transmitter 500 receives an original data unit 501 that may include, for example, text data, speech or audio data, image data, etc. The transmitter may perform source encoding that is the process of converting data of a given type to a form that is optimal for transfer, storage or further processing.

In this example, the source coding may be service-optimized encoding 520 that is a type of source encoding that equips the encoded data with an additional internal structure: a partition into blocks, the relative value of blocks for the application and interdependencies between the blocks. Examples may include multi-stream video/audio codecs (HEVC), codecs providing layered quantization, etc.

The next operation is to generate data representations 530 that is the generalization of the concept of a “PDU set”. It describes an output of application layer processing (e.g., an output of service-optimized encoding), which may be processed jointly by the application layer decoder at the receiver. The representation typically allows a description of an internal structure, including the data blocks, the value of the data blocks and interdependencies. Examples of representations may include encoded video frames with multiple resolution versions, encoded audio frames with multiple layers of residual vector quantization, etc.

The next operation is to generate data blocks 540 that are part of a data representation that may receive different treatments by the communication layers but packets and PDUs generated out of a single block may receive the same treatment. A data block may be considered to be correctly received if all its generated PDUs are correctly received. Data blocks of a representation may processed together by the application at the receiver 550 to reconstruct the original data unit.

IP packets may then be generated from the representations and transmitted to the receiver 550. The receiver 550 receives the IP packets 555 and, as described above, determines if all the data blocks 560 of the data representations are received. If all blocks 560 are received, the receiver 550 may reconstruct each representation 570 and then perform service-optimized decoding 580 to convert the encoded content back to its original form 590 (e.g., construct the original data unit 501), taking into account the data representation structure.

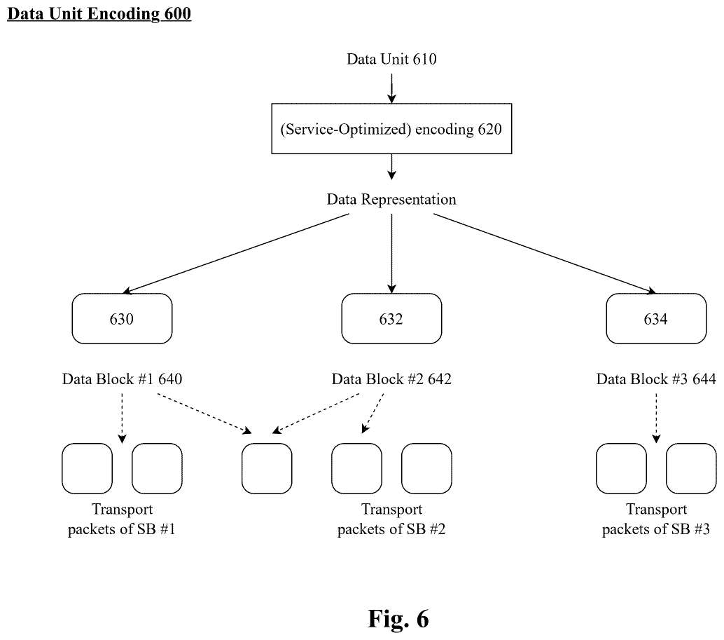

FIG. 6 shows an example of data unit encoding 600 according to various example embodiments. In an application-aware communication, a data unit 610 may be processed using a service-optimized encoding mechanism 620 to generate representations 630-634 typically comprising multiple data blocks 640-644.

This representation may have the following properties. A Data Unit 610→Data representations 630-634 (one-to-many correspondence). A single data unit may be mapped into one or many (in scenario with multi-modal data) service-optimized representations.

Data representation→Data Block (one-to-many mapping): multiple representations may be assigned to the same data unit and a single service-optimized representation may associated with a single data unit only.

Data block→packet (many-to-many mapping): data block may be mapped into multiple transport layer packets. A packet may include data of more than one data block.

Priority/relevance: each representation may be assigned a priority level or weight that defines the importance of the representation to reconstruct the original data unit in the decoding mechanism.

Interdependence: both blocks and representations may be interdependent. For example, two data blocks may be used together so that the source decoding mechanism at the receiver end is successful. The same may apply for two different representations.

Necessity and sufficiency: not all data blocks are necessary at the receiver for the reconstruction of the originally transmitted messages, e.g. representation.

Each receiver may have different requirements when it comes to the quality of reconstructed data units, depending on the application, transmission time, network capabilities, etc. For example, if the network is overloaded and the application is time-sensitive, a receiver/application may accept receiving a distorted version of the original message as long as the perceptual quality of the data is reasonable or as long as the message enables the receiver to perform its target task successfully.

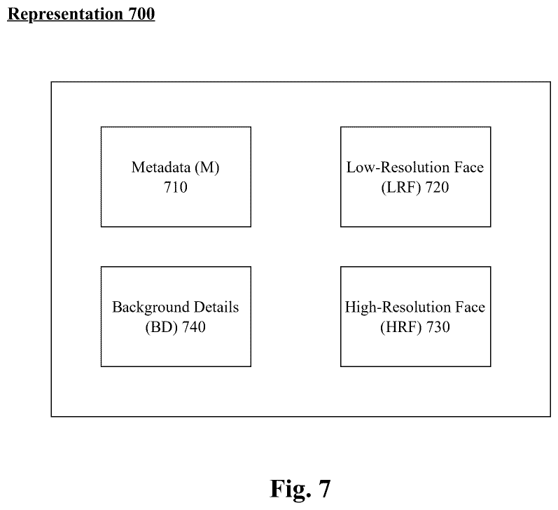

FIG. 7 shows an example representation 700 according to various example embodiments. The example representation 700 may be for a video frame but this is only an example and other data units may have similar representations. The example representation 700 includes metadata (M) 710, low-resolution face (LRF) data 720, high-resolution face (HRF) data 730 and background details (BD) data 740.

As described above, the data blocks and/or representation may have interdependencies that may be a logical condition for a data block of a representation to be valuable at the receiver end. For example, for a block by, the condition may have the form:

$${B}_{k} ∧ {P}_{k}$$

where Bₖ is a Boolean that represents the successful or non-successful reception of data block bₖ, Pₖ is a Boolean function of variables {Bᵢ, i=1 . . . K} (Bᵢ means block bᵢ of the same representation is received), satisfying the requirement: if all blocks of the representation are received, Pₖ should be satisfied.

Pₖ (Bₖ, B₋ₖ) expresses the dependency between Bₖ and other blocks B₋ₖ from the same representation, which is configured by the application.

In the example of FIG. 7, the dependencies may be described as follows: M 710 is independent, LRF 720 requires M 710, HRF 730 requires M 710 and BD 740 requires M 710 and either LRF 720 or HRF 730. Again, this is just an example of dependencies described for the illustrative purposes.

As also described above, weights may be defined as values in [0, 1], assigned to each block in the representation, such that the sum of weights over all blocks in the representation is equal to one. In the example of FIG. 7, the weights may be described as follows: M 710 has w=0.5, LRF 720 has w=0.3, HRF 730 has w=0 and BD 740 has w=0.2. Again, this is just an example of weights described for the illustrative purposes.

In the example embodiments, there may be two manners of configuring data representations to convey information to the communication system, a Data Category Based Configuration and a Flexible Configuration.

Initially, the Data Category Based Configuration is described. A data category may be defined as a flow of representations with a similar internal structure. In cellular systems, data categories may be standardized or operator-defined. The application layer agrees on a list of supported data categories and indicates to which data category a given representation belongs. A data category configuration may include information such as a list of blocks in a representation and dependencies between blocks. A representation may include information such as an indication of the data category and a number of packets per block. Information that may be placed in either data category or representation configuration may include weights of the blocks, an acceptable total value of data, an accepted delay budget per representation or per block and/or a flag indicating a strict latency limit or a strict data loss limit.

In a Flexible Configuration, each representation may have a unique internal structure. In this example, the representation may include information such as a list of blocks in a representation, dependencies between blocks, a number of packets per each block, weights of the blocks, an acceptable total value of data, an accepted delay budget per representation or per block and/or a flag indicating a strict latency limit or a strict data loss limit.

In both options, the configuration of a representation as well as the dependencies between representations may be conveyed to the communication system either in a specific header included at the beginning of every representation or in a specific configuration packet that may be sent at the beginning of every representation. The configuration may be provided based on a specific interface between the application layer and the communication system (e.g., modem).

A PDU may include additional information, available at the communication layers, to make it possible to associate a PDU with the proper representation and block(s). This information may be passed by the application layer to lower layers as part of a cross-layer header. Another option may be to provide this information via specific interface between the application layer and the communication system (e.g., modem) that can be an option for device-side service-optimized communication. The information to be conveyed with the PDU to the communication layers may include a Representation ID and indices of one or two blocks, whose data is included in the PDU.

Each PDU may include data of up to two blocks. This may cover all situations unless a block is smaller than a size of a PDU. For example, in one typical case, all PDUs are of a maximum size and all PDUs contain data of not more than two data blocks. In another case, PDUs do not have more than two data blocks but some data blocks are small resulting in the creation of PDUs having a size smaller than a typical PDU size. These small PDU sizes may result in some additional overhead.

As stated above, in some example embodiments, blocks may be soft blocks. For example, the described interface may be suitable for description of the limited number of relatively large data blocks, but in some types of representations, there may be a large number of small blocks. Typically, if the number of blocks is large, they follow a simple pattern, e.g., have equal size and their weights are progressed geometrically. To describe these situations, an extension to the service-optimized interface defining a novel type of data block is defined called a Soft Block. Soft blocks may be handled different from the usual blocks.

Soft blocks may have a regular structure with equal-sized sub-representations. For example, a soft block may have M×L sub-blocks, where M is the number of sub-blocks per layer and L is the number of layers. The weight of the entire soft block b may be represented by w_{b} and may be provided by the representation configuration. A parameter K is responsible for sub-blocks weight's progression w_{b}. Weights of the sub-blocks may be defined by the layer number, and the same for the sub-blocks within the layer. For example, the weights may be defined as:

$${w}_{b}^{l , m} := {c}_{b} \cdot {K}^{L - l} , l = 1 … L \\ {c}_{b} := \frac{{w}_{b} \cdot ( 1 - K )}{M \cdot ( 1 - {K}^{L} )} \\ {\sum }_{l , m} {w}_{b}^{l , m} = {w}_{b}$$

Thus, the internal structure of the soft block may be described fully by the three values (L, M, K), e.g., the number of layers, the number of sub-block per layer and the progressing coefficient of sub-blocks weights, respectively.

In the corresponding data category configuration or data representation configuration, some blocks of the representation may be marked as soft blocks. For each soft block, the structure (L, M, q) is provided, where L is the number of layers, M is the number of codewords per layer and K=2^{q} is the ratio of weights progression. For each soft representation, the condition for its reception acceptance (e.g., distortion threshold) may be provided and expressed as an absolute value within [0, w_{b}] or as a relative share in [0, 1] of the total block weight w_{b}. A soft block may be considered as received if the configured relaxed condition for reception is satisfied. All the other rules defined for legacy blocks may be similar for soft representations.

There may be additional assumptions for PDUs containing soft block information. For example, PDUs may contain an integer number (one or many) of entire sub-blocks of soft blocks. Soft blocks may be used with transport protocols that can support this requirement. A PDU containing soft block data may include the following information in its header. (lₛₜₐᵣₜ, lₙᵤₘ, mₛₜₐᵣₜ, mₙᵤₘ) that describes which part of soft block is covered by the PDU, where lₛₜₐᵣₜ is the starting layer of the block in the PDU, lₙᵤₘ is the number of layers of the block in the PDU, mₛₜₐᵣₜ is the starting vertical index of the sub-block in the PDU and mₙᵤₘ is the number of sub-blocks per layer in the PDU.

The example embodiments of the service optimized interface may be used in all use cases. The following provides some example use cases. In a first example use case, the service optimized interface may be used with video codecs. Classical codecs such as High Efficiency Video Coding (HEVC) and Versatile Video Coding (VVC) generate slices that may be considered as data blocks and assigned weights based on how important these slices are for the decoding mechanism. Moreover, video codecs generate different frames (I, P and B frames) that can be assigned different weights based on their importance of the data contained in each frame type.

In a second example use case, the service optimized interface may be used with audio codecs. Audio codecs such as Apple's ANETEK, Google's SoundSteam and Meta's EnCodec are based on residual vector quantization which makes them compatible with the data representation structure proposed. Each vector can be considered as a block and assigned a weight based on its order in the decoding mechanism.

In a third example use case, the service optimized interface may be used with XR codecs. The proposed service-optimized interface is a generalization of the PDU set concept which makes it compatible with XR traffic.

In a fourth example use case, the service optimized interface may be used with sensing data. There is no unified coding or compression mechanism for sensing data that provides more flexibility when generating the representations and blocks. For instance, AI techniques may be used to compress the data and weights may be assigned to parts of the latent representation depending on the bit/block-level relevance.

Furthermore, the information provided by the service optimized interface may be utilized by various layer of communication system. For example, at the PDCP layer, a discarding mechanism may be enhanced by considering service-optimized data structure to achieve better performance, e.g., discarding less important and useless data to free the resources for high priority data and enhance the overall performance of the system. In addition, discarding/throttling less important and useless data may reduce the energy consumed by the device. Furthermore, better utilization of network resources by discarding less important and useless data may save network resources which allows the network to serve more devices and applications.

At the Medium Access Control (MAC) layer, the service-optimized representation structure may be leveraged to optimize multiple procedures. For example, an application-optimized Hybrid Automatic Repeat Request (HARQ) may be made more efficient by reducing the number of unnecessary retransmissions and guaranteeing the delivery of the most relevant data first. Latency may be reduced by limiting the number of retransmissions for the least relevant MAC SDUs. The number of retransmissions per code block group may be defined based on the number and priority/weight of the successfully transmitted blocks. In addition, application-optimized scheduling may be selected to be transmitted at the expense of other data in the Radio Link Control (RLC) buffer. Data can be additionally protected to maximize the value of the delivered data at the receiver end.

Moreover, with regards to Modulation and Coding Scheme (MCS) Selection, a transport block containing more relevant data may be better protected to maximize the value of the delivered data at the receiver end.

In a second aspect, the example embodiments introduce an application-optimized transport block (TB) to reduce latency and improve the handling of the data based on its relevance for the user experience and achieve the application requirements.

Individual Quality of Service (QOS) flows may be mapped to one or more data radio bearers (DRBs). A PDU session may contain multiple QoS flows and several DRBs. A DRB may transport one or more QoS flows.

Upon receiving a scheduling grant, the transmitting device includes the amount of data needed to fill up the transport block and updates the header to indicate it is a segmented service data unit (SDU). To completely fill up the transport-block size, the last RLC PDU may contain a segment of an SDU. As part of channel-coding, a TB may be split into one or more code blocks (CBs) with error-correcting coding applied to each of the code blocks. A TB may be composed of hundreds of CBs.

Code-block segmentation may be used where the transport block, including the CRC, is split into multiple equal-sized code blocks. The set of possible transport-block sizes are such that it may be possible to split a too large transport block into smaller equally sized code blocks. In each Transmission Time Interval (TTI), a transport block of dynamic size may be transmitted over the radio interface to/from a device (in the case of spatial multiplexing of more than four layers, there may be two transport blocks per TTI).

The use of multiple parallel HARQ processes may result in data being delivered from the HARQ mechanism out of sequence. For many applications, this is acceptable and, if not, in-sequence delivery may be provided through the PDCP protocol. Without in-sequence delivery, each packet can be forwarded as soon as it is correctly received. There is a possibility for retransmission of code block groups (CBGs), a feature that can be beneficial for very large transport blocks or when a transport block is partially interfered by another pre-empting transmission.

For example, if per-CBG retransmission is configured, feedback is provided per CBG and only the erroneously received code block groups may be retransmitted. CBG retransmissions are invisible to the MAC layer and are handled in the physical layer, despite being part of the HARQ mechanism. It may not be possible, in the same HARQ process, to mix transmission of new CBGs belonging to another transport block with retransmissions of CBGs belonging to the incorrectly received transport block.

In the example embodiments, the service-optimized representation structure can be leveraged to optimize multiple procedures at the MAC layer. As described above, these procedures may include an application-aware HARQ, application-aware scheduling and MCS selection.

In the example embodiments, application-related information may be included in TBs. The application related information provided to the receiver in a TB may satisfy the following principles: the receiver should be informed about the data blocks IDs corresponding to each MAC SDU; the receiver should be able to identify if after the reception of MAC SDUs in this TB, the corresponding Data Block is fully received; and the receiver should be informed about the weight of the block and dependencies on other blocks, if any.

There may be various manners of conveying the TB application-related information to the receiver. These may include a MAC Header in the beginning of the Transport Block, MAC Sub-headers related to each MAC SDU, a combination of the first two manners, and a MAC Sub-header defined for all MAC SDUs of the same weight in a TB. Examples of these manners of conveying the application-related information are described below.

In a first example, the application data related information is conveyed in a MAC header. In this option, the MAC SDUs related to the same block may be located within TBs in a consecutive manner. This may simplify the indication of the block locations within the TBs.

The MAC header may include a list of blocks that have data in the TB. For each data block in the list, the following information may be provided: a Representation ID, a Data Block ID (local ID in the Representation), a Data Category ID (if applicable), Priority of the Data Block, Dependency of the Data Block, “End of Data Block” flag (e.g., the flag is a Boolean value which takes value TRUE if it is the last transmitted part of a Data Block), a “Number of TBs of the Data Block” (e.g., how many previous TBs contained data of this Data Block not counting Retransmissions), a “Number of MAC SDUs of the Data Block” (e.g., how many MAC SDUs of this Data Block were already allocated in previously scheduled TBs), a Number of MAC SDUs in the TB that belong to this SDU or a Position of the start and the end bit of the Data Block in the TB.

In a second example, the application data related information may be conveyed in MAC SDU Sub-Headers. In this option, the MAC SDUs of the same Data Block may not be located consecutively within TBs. The MAC SDU Sub-Header may include: a Data Representation ID, a Data Block ID (local ID in the Representation), a Data Category ID (if applicable), a priority of the Data Block, a dependency of the Data Block, Soft Block Information, an “End of Data Block” flag (e.g., the flag is a Boolean value which takes value TRUE if this MAC SDU is the last transmitted part of a Data Block), or a “Number of MAC SDUs of the Data Block” (e.g., how many MAC SDUs of this Data Block were already located in previously scheduled TBs and in the current TB before the considered MAC SDU). If the MAC SDU corresponds to a Soft PDU, the MAC SDU Sub-Header may additionally include (lₛₜₐᵣₜ, lₙᵤₘ, mₛₜₐᵣₜ, mₙᵤₘ) that were described in detail above. In this case, RLC Segmentation may preserve sub-blocks.

In a third example, the application data related information may be conveyed by both the MAC header and the MAC SDU Sub-Headers. In this option, the MAC SDUs of the same Data Block may be located consecutively within TB. The MAC Header may include a list of data blocks that have data in the TB. For each data block in this list, the MAC header may include, a Data Representation ID, a Data Block ID (local ID in the Representation), a Data Category ID (if applicable), a priority of the block, a dependency of the Block, Soft Block Information, an “End of Data Block” flag, a “Number of TBs of the Data Block” or a “Number of MAC SDUs of the Data Block”. The MAC SDU Sub-Header may include a Data Representation ID and a Data Block ID (local ID in the Representation). If the MAC SDU corresponds to a Soft PDU, the MAC SDU Sub-Header may additionally include (lₛₜₐᵣₜ, lₙᵤₘ, mₛₜₐᵣₜ, mₙᵤₘ) that were described in detail above. In this case, RLC Segmentation may preserve sub-blocks.

In a fourth example, the application data related information may be conveyed by weight-specific MAC SDU Sub-Headers. In this option, a MAC sub-header may be created for all data blocks of the same weight or those that have a weight within a predefined range. Weight-specific MAC sub-headers may include a list of data blocks that have data in the TB and a weight in a predefined range. The MAC sub-header may include the priority range of the data blocks and for each Data Block in the list, the following information may be provided, a Data Representation ID, a Data Block ID (local ID in the Representation), a Data Category ID (if applicable), a priority of the Data Block, a dependency of the Data Block, Soft Block Information, an “End of Data Block” flag, and a “Number of MAC SDUs of the Data Block”.

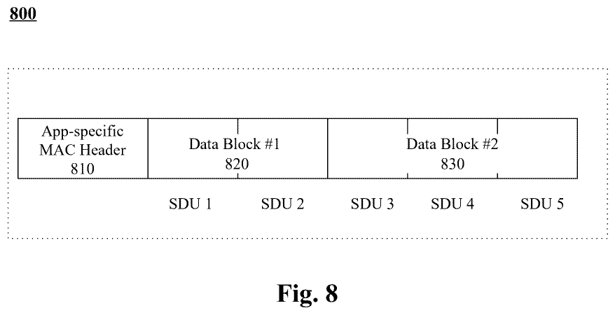

FIG. 8 shows an example of an application aware transport block (TB) 800 according to various example embodiments. The example application aware TB comprises an application specific MAC header 810, a first data block 820 and a second data block 830. The data blocks 820 and 830 include SDUs.

The application-specific MAC Header (if used) is added at the beginning of the TB. MAC SDUs of the same blocks may be allocated consecutively. If a MAC SDU contains data from two data blocks, it may be put between these data blocks allocations in the TB. As described above, an application-specific MAC SDU sub-headers may be added to the respective original MAC SDU sub-headers.

In some example embodiments, the data blocks within the TB are ordered from the highest to the lowest priority. Thus, even though the decoding of MAC SDUs sub-headers depend on one another, only low packet priority MAC SDUs would wait for higher priority MAC SDUs to be decoded. This implementation results in minimal changes to the current structures of TBs and CBs. Since the high weight MAC SDUs are decoded first, if they are correctly decoded and total weight of the correctly decoded MAC SDUs is higher than a predefined threshold, the MAC SDUs can be passed to higher layers and non-decoded MAC SDUs of lower weight may be discarded. In the HARQ process, retransmission of CBGs with the lowest weight may be ignored except if the retransmission will be done due to other failure of CBGs with a higher weight. Optimized resource allocation and scheduling policies may be used for different CBGs to account for the relevance of the information contained in the CBGs which is captured through the weights.

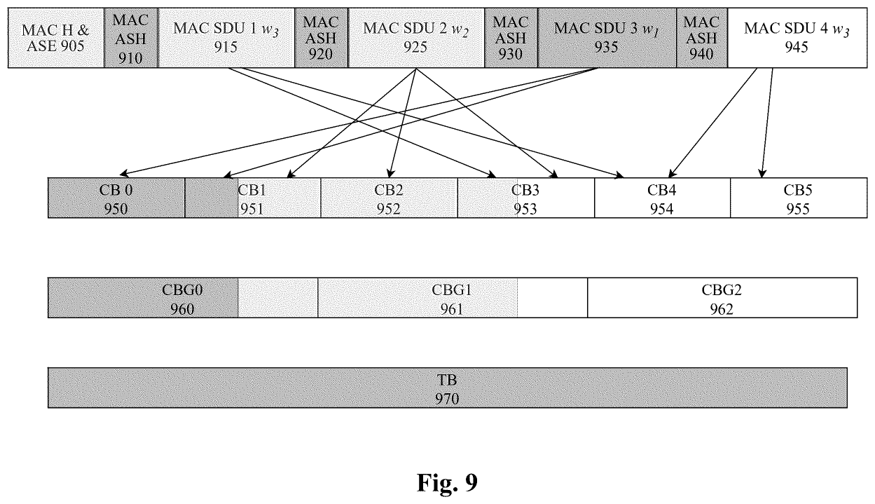

FIG. 9 shows an example of ordering data blocks from the highest to the lowest priority in a TB according to various example embodiments. FIG. 9 shows an application specific MAC header 905, application specific MAC sub-headers 910, 920, 930 and 940. The SDUs 915, 925, 935 and 945 all have a corresponding weight, e.g., SDU 915 have weight w₃, SDU 925 have weight w₂, SDU 935 have weight w₁ and SDU 945 have weight w₃. In this example, w₁>w₂>w₃. Thus, as shown in FIG. 8, the SDUs are placed into code blocks in weight order, e.g., the SDU 935 (weight w₁) into codeblocks 950 and 951, SDU 925 (weight w₂) into code blocks 951-953, and SDUs 915 and 945 (weight w₃) into code blocks 953-955. The code blocks 950-955 are used to generate code block groups (CBGs) 960-962 for the TB 970.

In other example embodiments, multiple TBs are generated from a number of MAC SDUs instead of a single TB. A TB is created for every weight or interval of weights. In these example embodiments, Different MCS selection techniques may be used based on the relevance/weight of the TBs. Moreover, the HARQ mechanism may be optimized based on the weight of the TB/CBGs, e.g., use more retransmissions for TBs/CBGs with a higher weight.

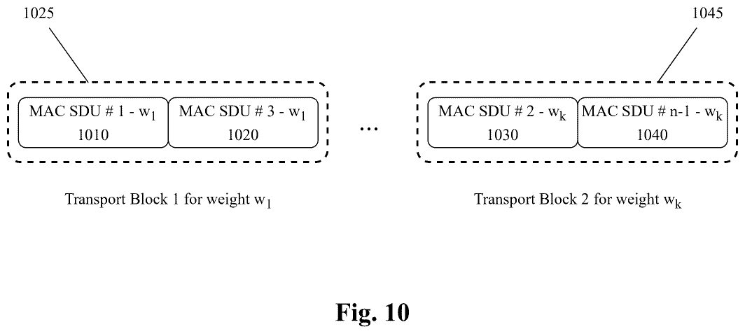

FIG. 10 shows an example of TBs generated based on SDU weight according to various example embodiments. In the example of FIG. 10, there may be multiple SDUs. The SDUs 1010 and 1030 may have a weight w₁. The SDUs 1030 and 1040 may have a weight Wₖ. Thus, the SDUs 1010 and 1020 having the weight w₁ may be used to generate the TB 1025 and the SDUs 1030 and 1040 having the weight we may be used to generate the TB 1045. In this example, the weights may be w₁>w₂>wₖ.

In further example embodiments, MAC SDUs that belong to 1) the same Data Block or 2) MAC SDUs that have a weight within a given range may be mapped to the same CBGs. In these example embodiments, code blocks of the same weight may receive the same treatment when transmitted, e.g., HARQ handling, scheduling and resource allocation to guarantee their transmission within specific time constraints and with reliability levels depending on the relevance of these blocks. The CBs of a given priority/weight are still identifiable and the decoding of MAC SDUs sub-headers of the same weight depend on one another. For a more efficient decoding of the CBGs, an application-specific MAC header per weight may be defined where the sub-headers of MAC SDUs of the same weight may be concatenated into a single header that may be aligned with the first CBG of the corresponding MAC SDUs weight. The first CBG may receive higher protection to guarantee that all MAC SDUs of the same priority may be identified.

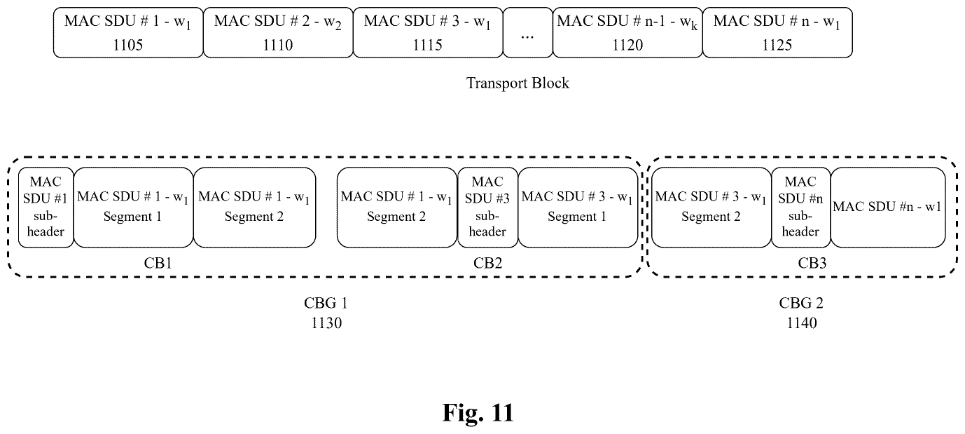

FIG. 11 shows an example of TBs generated based on MAC SDUs that belong to a same Data Block or that have a weight within a given range according to various example embodiments. As shown on FIG. 11, there are SDUs 1105-1125 having various weights. These SDUs are grouped into CBGs based on weights. For example, the CBG 1 1130 comprises the MAC sub-header for SDU 1105 and two segments of the SDU 1105. The CBG 1 1130 further comprises the MAC sub-header for SDU 1115 and one segment of the SDU 1115. The SDU 1105 and the SDU 1115 are grouped because they have the same weight w₁. Similarly, the CBG 2 1140 comprises a second segment of the SDU 1115, the MAC sub-header for SDU 1125 and the SDU 1125. Again, the SDU 1115 and the SDU 1125 are grouped because they have the same weight w₁. Additional CBGs may be generated based on the weight of the remaining SDUs.

In additional example embodiments, when the application-specific information is conveyed by a MAC Header at the beginning of the TB, this may be transmitted with additional protection. For example, a TB may be composed of MAC SDUs from different data blocks. A global header may be added at the beginning of each TB to identify the position of the MAC SDUs within the TB. The global header may contain information about the number of MAC SDUs and their corresponding size/location.

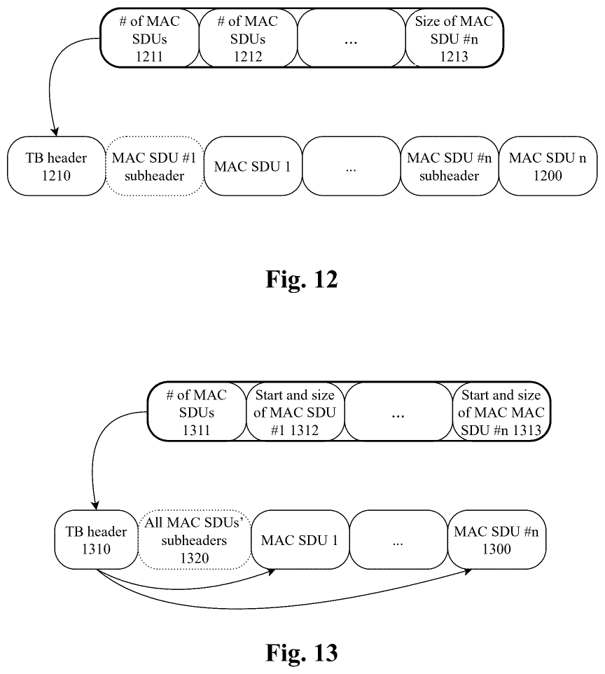

FIG. 12 shows a first example of a global TB MAC header according to various example embodiments. FIG. 12 shows a TB 1200 that includes a global TB MAC header 1210. The global TB MAC header 1210 comprises a number of MAC SDUs 1211 and a list of MAC SDU sizes 1212-1213. Given that the size of CBs is fixed and known, the receiver that decodes the global TB MAC header 1210, may determine the location of all the MAC SDUs.

FIG. 13 shows a second example of a global TB MAC header according to various example embodiments. FIG. 13 shows a TB 1300 that includes a global TB MAC header 1310 that includes a number of MAC SDUs 1311 and a start and size 1312-1313 of all the MAC SDUs in the TB. In addition, the TB 1330 includes a concatenation 1320 of all the sub-headers of all the MAC SDUs and positioned at the beginning of the TB 1300. To locate the MAC SDUs within the TB 1300, the global header 1310 includes pointers to the location of all the MAC SDUs.

From a system level perspective, a Block Error Rate (BLER) may be targeted to a Target BLER, where BLER includes the impact of header loss. BLER may be determined as follows:

$$BLER = HEADER\_ER + CB\_ER - Header\_ER \cdot CB\_ER ,$$

where Header_ER is an error rate of the MAC header,
CB_ER is an error rate of data code blocks, and
Header_ER·CB_ER is a probability that both the header and the CB are lost.

If the BLER Target is fixed, assuming that data is larger than header in the TB, the condition on CB_ER may be relaxed, keeping the target BLER. This may be achieved when Header_ER is minimized (e.g., selected to be reasonably close to zero). There may be various options of protecting the TB header, some examples of which are described below.

In a first option, two MCSs may be selected, one for data and the other one for the header. Each MCS targets its own error rate, where typically, error rate for the header is very low (e.g., less that 1%). A Downlink Control Information (DCI) message may be modified to provide both MCS values, and indicate the size of the header.

In a second option, an MCS table may be standardized, where each MCS index corresponds to a first MCS for data and a second MCS for the header (e.g., where the second MCS is typically more robust than the first MCS). The DCI may be modified to indicate the size of the header.

In a third option, the network may configure a UE via a Radio Resource Control (RRC) message with the parameter that corresponds to a difference between MCS for data and MCS for the header (e.g., difference=2 MCS values). Again, the DCI may be modified to indicate the size of the header.

In some example embodiments, a TB may be restricted to include MAC SDUs of a single Data Block only. In this case, the relation between data blocks and TBs is one-to-many. In these example embodiments, each data block may have specific optimized MCS selection, scheduling and resource allocation to guarantee their transmission within specific time constraints and with reliability level, depending on the relevance of these blocks. The CBG structure may not be used since the whole data block may be delivered in order. Thus, the retransmission decisions may be made at the level of TBs. The application-aware BLER policy may also be configured per TB and provided in an extended DCI. Thus, the receiver HARQ process may implement application-aware retransmissions without checking MAC layer headers/sub-headers. Application-specific headers may have a more compact structure, reducing overhead.

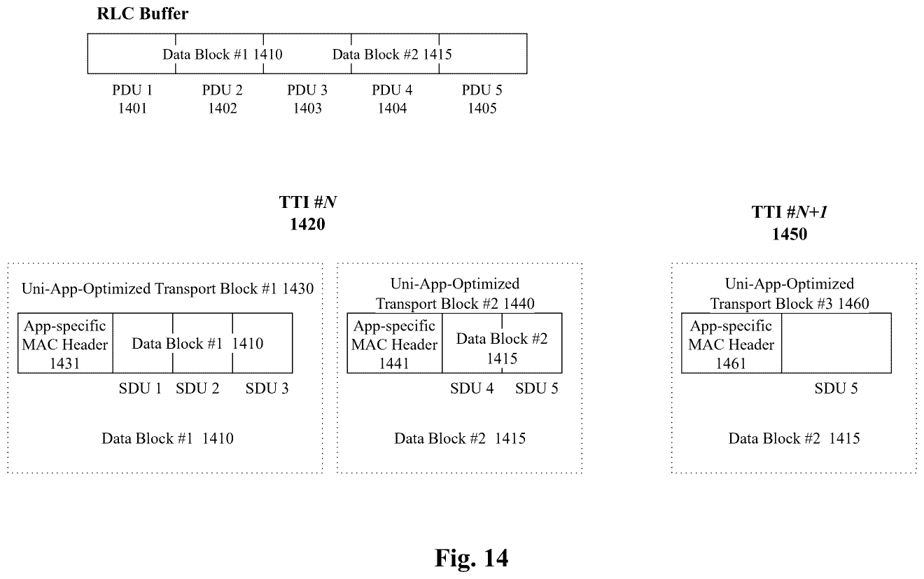

FIG. 14 shows an example of TBs that are restricted to include MAC SDUs of a single data block according to various example embodiments. FIG. 14 shows an RLC buffer that includes five (5) PDUs 1401-1405 that are distributed among two (2) data blocks 1410 and 1415. In this example, two application-optimized TBs may be scheduled for the same UE in TTI N 1420. Thus, a first TB 1430 may include the application-specific MAC header 1431 and the SDUs associated with the data block 1410. The second TB 1440 may include the application-specific MAC header 1441 and the SDUs associated with the data block 1415. The SDU 3 may be repeated because it belongs to both data blocks 1410 and 1415 and these may be handled in the receiver independently (e.g., one of the SDU 3 may be dropped).

In TTI N+1 1450, a single TB 1460 comprising an application-specific MAC header 1461 and the SDU 5 associated with the data block 1415. In this example, the data block 1415 may be transmitted in two TBs because of the size of the TBs (e.g., based on available radio resources).

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to deliver targeted content that may be of greater interest to the user in accordance with their preferences. Accordingly, use of such personal information data enables users to have greater control of the delivered content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry coupled to memory, wherein the processing circuitry is configured to:
map a data unit to one or more representations;
map each of the representations to one or more data blocks, wherein each of the data blocks comprises a weight; and
encode the one or more data blocks of each of the representations into one or more packets.

2. The apparatus of claim 1, wherein the weight is associated with a relevance to reconstruct data from the data unit.

3. The apparatus of claim 1, wherein a first representation is dependent on a second representation or a first data block is dependent on a second data block.

4. The apparatus of claim 1, wherein the data unit corresponds to an image and wherein a representation comprises a first data block associated with metadata for the image, a second data block associated with low resolution image data, a third data block associated with high resolution image data and a fourth data block associated with background image data.

5. The apparatus of claim 4, wherein each of the first through fourth data blocks has a different weight.

6. The apparatus of claim 1, wherein each of the representations is a member of a data category.

7. The apparatus of claim 6, wherein configuration information for each data category comprises a list of data blocks in a representation, and dependencies between blocks in a representation.

8. The apparatus of claim 7, wherein configuration information for each data category further comprises weights of the data blocks, acceptable total value of data, acceptable delay budget per representation or per block and a flag indicating a strict latency limit or a strict data loss limit.

9. The apparatus of claim 6, wherein each of the representations comprise an indication of the data category of which the representation is a member and a number of packets per each data block.

10. The apparatus of claim 9, wherein each of the representations further comprise weights of the data blocks, acceptable total value of data, acceptable delay budget per representation or per block and a flag indicating a strict latency limit or a strict data loss limit.

11. The apparatus of claim 1, wherein a protocol data unit (PDU) including a packet comprises a header indicating an indication of a representation identification (ID) of the PDU and an index of data blocks included in the PDU.

12. The apparatus of claim 11, wherein the header further comprises one or more of a data category ID, a priority of the data blocks, dependencies of the data blocks, an “End of Data Block” flag indicating whether the data block is an end of the data block, a “Number of transport blocks (TBs) of the Data Block” indicating a number of previous TBs that contained data of the data block, a “Number of Medium Access Control (MAC) Service Data Units (SDUs) of the Data Block” indicating a number of MAC SDUs of this Data Block were already allocated in previously scheduled TBs, a number of MAC SDUs in the TB that belong to a current SDU or a position of a start and an end bit of the data block in the TB, or an indication that that the data block comprises multiple sub-blocks.

13. The apparatus of claim 1, wherein one of the data blocks comprises an indication that the block comprises multiple sub-blocks, wherein each sub-block has an individual weight.

14. The apparatus of claim 1, wherein the processing circuitry is further configured to:
order the blocks within a transport block (TB) from the highest to the lowest priority.

15. The apparatus of claim 1, wherein the processing circuitry is further configured to:
generate multiple transport blocks (TBs) from a number of Medium Access Control (MAC) Service Data Units (SDUs).

16. The apparatus of claim 1, wherein the processing circuitry is further configured to:
map Medium Access Control (MAC) Service Data Units (SDUs) that belong to a same data block or MAC SDUs that have a weight within a given range to a same code block group (CBG).

17. The apparatus of claim 1, wherein a transport block (TB) including the data blocks comprises a global TB Medium Access Control (MAC) header followed by a list of MAC Service Data Unit (SDU) sizes.

18. The apparatus of claim 1, wherein sub-headers of Medium Access Control (MAC) Service Data Units (SDUs) including the data blocks are concatenated and positioned at a beginning of a transport block (TB).

19. The apparatus of claim 1, wherein a transport block comprising the one or more data blocks includes a header portion and a data portion, wherein the header portion is encoded using a first modulation and coding scheme (MCS) and the data portion is encoded using a second MCS, wherein the first MCS is more robust than the first MCS.

20. The apparatus of claim 1, wherein a transport block comprises Medium Access Control Service Data Units of only a single data block of the one or more data blocks.
